(19) United States
(12) Patent Application Publication
(10) Pub. No.: US 2026/0118305 A1
(43) Pub. Date: Apr. 30, 2026

(54) HYDROGEN SULFIDE DETECTION DEVICE

(71) Applicant: TOYOTA JIDOSHA KABUSHIKI KAISHA, Toyota-shi (JP)

(72) Inventor: Mai FUJIWARA, Handa-shi (JP)

(73) Assignee: TOYOTA JIDOSHA KABUSHIKI KAISHA, Toyota-shi (JP)

(21) Appl. No.: 19/241,922

(22) Filed: Jun. 18, 2025

(30) Foreign Application Priority Data
Oct. 24, 2024 (JP) 2024-187588

(51) Int. Cl. G01N 27/12; H01M 10/0562; H01M 10/42

(52) U.S. Cl. CPC G01N 27/12; H01M 10/4285; H01M 10/0562; H01M 2300/0068

(57) ABSTRACT

A hydrogen sulfide detection device includes a substrate including a pattern formed from a metal that reacts with hydrogen sulfide to be corroded. The pattern includes a detection portion that detects the hydrogen sulfide by corrosion of the metal exposed on a surface of the substrate. The detection portion is covered by a filter formed to allow passage of a hydrogen sulfide gas and to block passage of particles generated from the corroded metal.

### CROSS-REFERENCE TO RELATED APPLICATION

This application claims priority to Japanese Patent Application No. 2024-187588 filed on Oct. 24, 2024. The disclosure of the above-identified application, including the specification, drawings, and claims, is incorporated by reference herein in its entirety.

### BACKGROUND

### 1. Technical Field

The present disclosure relates to a hydrogen sulfide detection device that is applied to a battery pack that stores a battery cell containing a sulfide-based electrolyte.

### 2. Description of Related Art

All-solid-state batteries are attracting attention as next-generation battery cells that constitute battery packs. The all-solid-state batteries have advantages such as high safety and a long life, compared to conventional batteries that use a liquid electrolyte. In particular, all-solid-state batteries that use a sulfide-based electrolyte have a large capacity and a high output, and are expected to be used for vehicle batteries.

On the other hand, when a battery cell containing a sulfide-based electrolyte is constituted as a battery cell of an all-solid-state battery, there is a risk that a hydrogen sulfide gas is generated due to a failure. The hydrogen sulfide gas is toxic and corrodes nearby metal components. Therefore, there is a demand for a technique of appropriately detecting the generation of hydrogen sulfide in a battery pack that stores a battery cell containing a sulfide-based electrolyte.

Japanese Unexamined Patent Application Publication No. 2017-199667 (JP 2017-199667 A) discloses a detection system in which a battery cell is provided with a resistance change member including a resistance change material whose electrical resistance changes upon chemical reaction with hydrogen sulfide, and the generation of hydrogen sulfide in the battery cell is determined based on a detection value between terminals of the resistance change member.

### SUMMARY

In recent years, it has been considered to use a metal that reacts with hydrogen sulfide to be corroded as a technique of detecting the generation of hydrogen sulfide in a battery pack. With this technique, the generation of hydrogen sulfide can be detected by detecting a change in resistance due to metal corrosion or by detecting a break or a short circuit in a wire due to metal corrosion. By utilizing metal corrosion in this way, it is expected to implement a hydrogen sulfide detection device with high detection accuracy.

On the other hand, in a hydrogen sulfide detection device that utilizes metal corrosion, there is a possibility that particles generated from the corroded metal scatter. Since the corroded metal is electrically conductive, there is a risk that a short circuit occurs in a device in the battery pack, causing the device to fail, when particles of the corroded metal scatter within the battery pack.

The present disclosure has been made in view of the above issue. One object of the present disclosure is to provide a hydrogen sulfide detection device that utilizes metal corrosion, in which it is possible to suppress scattering of particles of a corroded metal.

An aspect of the present disclosure relates to a hydrogen sulfide detection device that is applied to a battery pack that stores a battery cell containing a sulfide-based electrolyte. The hydrogen sulfide detection device includes a substrate including a pattern made of a metal that reacts with hydrogen sulfide to be corroded. The pattern includes a detection portion that detects the hydrogen sulfide by corrosion of the metal exposed on a surface of the substrate. The detection portion is covered by a filter that allows passage of a hydrogen sulfide gas and that blocks passage of particles generated from the corroded metal.

In the present disclosure, the detection portion of the substrate is covered by a filter that allows passage of a hydrogen sulfide gas and that blocks passage of particles generated from the corroded metal. This makes it possible to suppress scattering of particles of the corroded metal while maintaining the detection function of the hydrogen sulfide detection device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating the configuration of a hydrogen sulfide detection device according to a first embodiment;

FIG. 2 is a flowchart illustrating the process flow of a process executed by a monitoring circuit;

FIG. 3 is a schematic diagram for explaining the function of a filter that covers a detection portion of a substrate;

FIG. 4 is a schematic diagram illustrating an example of a first modification of the hydrogen sulfide detection device according to the first embodiment;

FIG. 5 is a schematic diagram illustrating an example of a second modification of the hydrogen sulfide detection device according to the first embodiment; and

FIG. 6 is a schematic diagram illustrating the configuration of a hydrogen sulfide detection device according to a second embodiment.

### DETAILED DESCRIPTION OF EMBODIMENTS

Embodiments of the present disclosure will be described below with reference to the attached drawings. The same or corresponding components in the drawings are given the same reference numerals to simplify or omit description of such components.

### 1. First Embodiment

### 1.1 Configuration

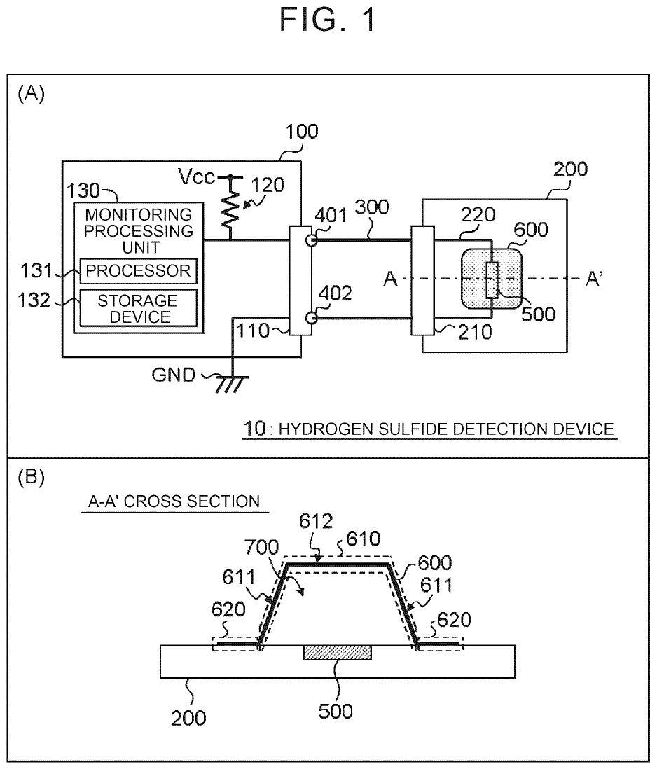

FIG. 1 is a schematic diagram illustrating the configuration of a hydrogen sulfide detection device 10 according to a first embodiment. The portion (A) in FIG. 1 illustrates the overall configuration of the hydrogen sulfide detection device 10 according to the first embodiment. The portion (B) in FIG. 1 illustrates a cross-sectional view taken along the cutting line A-A′ indicated in the portion (A).

The hydrogen sulfide detection device 10 is applied to a battery pack that stores a battery cell containing a sulfide-based electrolyte, and detects the generation of hydrogen sulfide. The hydrogen sulfide detection device 10 is stored in the battery pack together with the battery cell. The battery cell containing a sulfide-based electrolyte is typically an all-solid-state battery that uses a solid sulfide-based electrolyte. The form of the battery cell is not particularly limited. For example, the battery cell may be of a laminate type or a rectangular type. The all-solid-state battery that uses a sulfide-based electrolyte has a large capacity and a high output, and is suitable for vehicle batteries. Thus, the battery pack to which the hydrogen sulfide detection device 10 is applied may be a battery to be mounted on a vehicle, in particular.

The hydrogen sulfide detection device 10 includes a monitoring circuit 100 and a substrate 200. The substrate 200 is a printed circuit board (PCB) that includes a pattern 220 formed of a metal. The substrate 200 may be a flexible printed circuit (FPC) board, in particular.

The monitoring circuit 100 and the substrate 200 are connected to an external device via connectors 110 and 210, respectively. As illustrated in FIG. 1, the monitoring circuit 100 and the substrate 200 are connected by a cable 300. The cable 300 and the pattern 220 of the substrate 200 form a wire that electrically connects a first node 401 and a second node 402 (hereinafter also simply referred to as a wire). The wire is a single current path.

The monitoring circuit 100 monitors a voltage between the first node 401 and the second node 402. In the monitoring circuit 100, the first node 401 is connected to a power supply of a voltage Vcc (e.g., 5 V) via a resistor 120, and the second node 402 is connected to a ground GND of a reference potential (e.g., 0 V). The monitoring circuit 100 includes a monitoring processing unit 130. The monitoring processing unit 130 is a computer that executes a process of monitoring a voltage. In particular, the monitoring processing unit 130 may be a microcontroller. The monitoring processing unit 130 is disposed so as to receive a potential between the resistor 120 and the first node 401 as an input. For example, when the monitoring processing unit 130 is a microcontroller, an input port of the microcontroller is connected between the resistor 120 and the first node 401. The resistor 120 serves as a pull-up resistor for the monitoring processing unit 130. For example, the resistor 120 has a resistance value of about 10 kΩ. The monitoring circuit 100 constitutes a voltage dividing circuit, and the monitoring processing unit 130 can detect a voltage between the first node 401 and the second node 402.

The configuration of the monitoring circuit 100 illustrated in FIG. 1 is exemplary, and the monitoring circuit 100 can have other configurations. For example, a voltage between the first node 401 and the second node 402 can be indirectly detected by measuring a voltage between both ends of the resistor 120. That is, monitoring the voltage between the first node 401 and the second node 402 includes monitoring the voltage between both ends of the resistor 120. Thus, the monitoring processing unit 130 may be disposed so as to measure the voltage between both ends of the resistor 120. Furthermore, the monitoring circuit 100 can be configured to include a pull-down resistor for the monitoring processing unit 130, for example. That is, the first node 401 may be directly connected to a power supply, and the second node 402 may be connected to the ground GND via a resistor. The monitoring processing unit 130 may then be disposed so as to detect a voltage between the first node 401 and the second node 402. For example, an input port of the microcontroller is connected between the resistor and the second node 402.

The monitoring processing unit 130 includes one or more processors 131 (hereinafter simply referred to as a processor 131) and one or more storage devices 132 (hereinafter simply referred to as a storage device 132). The processor 131 executes various processes. The processor 131 is composed of a general-purpose processor, an application-specific processor, a central processing unit (CPU), a graphics processing unit (GPU), an application specific integrated circuit (ASIC), a field-programmable gate array (FPGA), an integrated circuit, a conventional circuit, or a combination of one or more of these, for example. The processor 131 may also be referred to as processing circuitry. The storage device 132 stores various information necessary for the processor 131 to execute processes. The storage device 132 is composed of a recording medium such as a random access memory (RAM), a read only memory (ROM), a solid state drive (SSD), or a hard disk drive (HDD), for example. The storage device 132 stores a computer program that can be executed by the processor 131. The computer program is composed of a plurality of instruction codes that describe the processes to be executed by the processor 131. The computer program is recorded in a computer-readable recording medium. The functions of the monitoring processing unit 130 are implemented through cooperation between the processor 131 that executes the computer program and the storage device 132.

The metal forming the pattern 220 of the substrate 200 is a metal that reacts with hydrogen sulfide to be corroded. For example, copper or silver is used as the metal. Furthermore, the pattern 220 includes a detection portion 500 that detects hydrogen sulfide. In the first embodiment, the detection portion 500 is formed by exposing a part of the metal of the pattern 220 on a surface of the substrate 200. That is, the detection portion 500 is an exposed metal portion of the pattern 220. This can be implemented by configuring the substrate 200 such that a part of the pattern 220 is not subjected to surface protection (such as coverlay or solder resist) or surface treatment (such as flux or gold plating). The hydrogen sulfide detection device 10 according to the first embodiment can detect the generation of hydrogen sulfide using the detection portion 500 as follows.

At normal times, that is, when hydrogen sulfide is not being generated from the battery cell, the path between the first node 401 and the second node 402 is simply a current path having no resistance. Thus, the monitoring processing unit 130 acquires the reference potential of the ground GND as a detection value. At abnormal times, that is, when hydrogen sulfide is being generated from the battery cell, the metal of the detection portion 500 reacts with the generated hydrogen sulfide to be corroded. When the metal is corroded to become a sulfide, the resistance value of the detection portion 500 increases. Furthermore, the metal tends to move radially as the corrosion progresses. The corroded metal also moves when subjected to vibration or impact. For example, the corroded metal moves when subjected to vehicle vibrations. As the corrosion progresses in this manner, the metal of the detection portion 500 gradually disappears and the cross-sectional area decreases. This further increases the resistance value of the detection portion 500. Then, the metal of the detection portion 500 eventually breaks.

In the course in which the resistance value of the detection portion 500 increases, the monitoring processing unit 130 acquires the divided voltage due to the resistance value of the detection portion 500 as the detection value. That is, as the resistance value of the detection portion 500 increases, the detection value of the monitoring processing unit 130 increases from the reference potential. Then, when the metal of the detection portion 500 eventually breaks, the power supply voltage Vcc is input as it is to the monitoring processing unit 130. That is, the monitoring processing unit 130 acquires the voltage Vcc as the detection value.

In this manner, when hydrogen sulfide is generated from the battery cell, the detection state of the detection portion 500 appears as the voltage between the first node 401 and the second node 402. That is, when hydrogen sulfide is generated from the battery cell, the detection value of the monitoring processing unit 130 changes from the reference potential to Vcc. Thus, the monitoring processing unit 130 can determine whether hydrogen sulfide is being generated from the battery cell based on a change in the detection value (the voltage between the first node 401 and the second node 402). For example, when the amount of variation in the detection value from an initial value becomes greater than a threshold value, the monitoring processing unit 130 determines that hydrogen sulfide is being generated from the battery cell. Alternatively, the monitoring processing unit 130 may use the detection value as it is without calculating an amount of variation in the detection value, and determine that hydrogen sulfide is being generated from the battery cell when the detection value becomes greater than a threshold value.

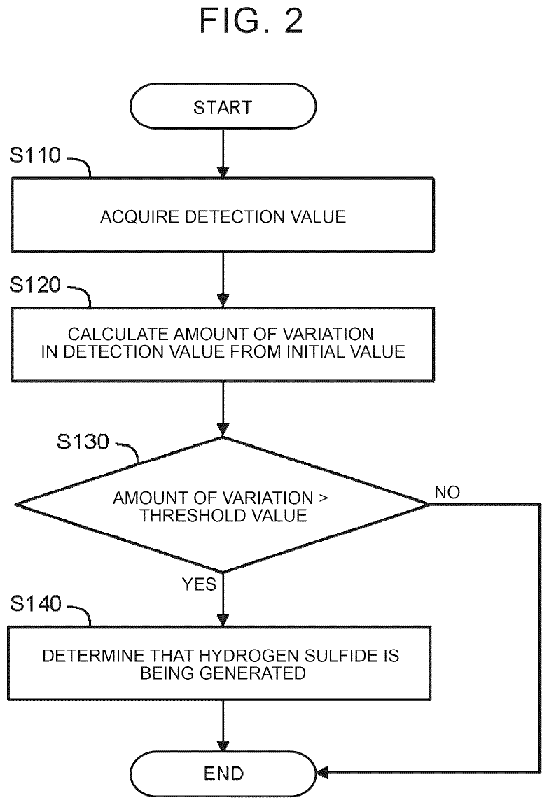

FIG. 2 is a flowchart illustrating the process flow of a process executed by the monitoring circuit 100 (more specifically, the monitoring processing unit 130). The process flow illustrated in FIG. 2 is repeatedly executed at predetermined processing intervals.

First, in step S110, the monitoring circuit 100 acquires a detection value. Next, in step S120, the monitoring circuit 100 calculates an amount of variation in the detection value from the initial value. In the above-described hydrogen sulfide detection device 10, the initial value of the detection value is the reference potential, and the amount of variation from the initial value is the difference between the detection value and the reference potential. In particular, when the reference potential is 0 V, the amount of variation from the initial value coincides with the detection value. Next, in step S130, the monitoring circuit 100 determines whether the calculated amount of variation is greater than a threshold value. When the amount of variation is not greater than the threshold value (step S130: No), the monitoring circuit 100 determines that hydrogen sulfide is not being generated, and ends the current process. When the amount of variation is greater than the threshold value (step S130: Yes), the monitoring circuit 100 determines that hydrogen sulfide is being generated from the battery cell (step S140). The monitoring circuit 100 may further execute a process of warning a user (e.g., a vehicle driver) that hydrogen sulfide is being generated through display or a sound.

The process flow illustrated in FIG. 2 is exemplary, and the monitoring circuit 100 can also determine that hydrogen sulfide is being generated from the battery cell by other process flows. For example, as described above, the monitoring circuit 100 may be configured to determine that hydrogen sulfide is being generated from the battery cell by using the detection value as it is, without calculating the amount of variation in the detection value. In this case, the process of step S120 is skipped in the process flow illustrated in FIG. 2. Also, in step S130, it is determined whether the detection value is greater than a threshold value. Then, the monitoring circuit 100 may determine that hydrogen sulfide is being generated from the battery cell when the detection value is greater than the threshold value.

As described above, the hydrogen sulfide detection device 10 according to the first embodiment can detect the generation of hydrogen sulfide by the corrosion of the metal of the detection portion 500. On the other hand, in the hydrogen sulfide detection device 10, there is a possibility that particles generated from the corroded metal scatter. Since the corroded metal is electrically conductive, there is a risk that a short circuit occurs in a device in the battery pack, causing the device to fail, when particles of the corroded metal scatter within the battery pack. The occurrence of this situation is of particular concern in environments where the hydrogen sulfide detection device 10 is easily subject to vibration or impact, such as when the hydrogen sulfide detection device 10 is applied to a vehicle battery.

Thus, in the hydrogen sulfide detection device 10 according to the first embodiment, as illustrated in FIG. 1, the detection portion 500 of the substrate 200 is covered by a filter 600. The filter 600 is formed to allow passage of the hydrogen sulfide gas and to block passage of particles generated from the corroded metal (sulfide). In general, the size of molecules of a hydrogen sulfide gas is much smaller than the size of particles generated from a corroded metal. Thus, for example, the filter 600 can be formed from a filter medium having a pore size larger than the size of molecules of the hydrogen sulfide gas and smaller than the size of particles generated from the corroded metal.

In the example illustrated in FIG. 1, as illustrated in the portion (B) in FIG. 1, the filter 600 includes a cover portion 610 that covers the detection portion 500, and a sealing portion 620 that adheres to the surface of the substrate 200 and seals a space 700 covered by the cover portion 610. Furthermore, in the example illustrated in FIG. 1, the cover portion 610 includes a surface 611 (hereinafter referred to as a first surface 611) that extends in an inclined manner from an end portion of the sealing portion 620 toward the inside of the space 700, and a surface 612 (hereinafter referred to as a second surface 612) that faces the detection portion 500 and is parallel to the surface of the substrate 200.

With the detection portion 500 covered by the filter 600 in this manner, it is possible to suppress scattering of particles generated from the corroded metal. The function of the filter 600 will be described in more detail below.

### 1.2 Function of Filter

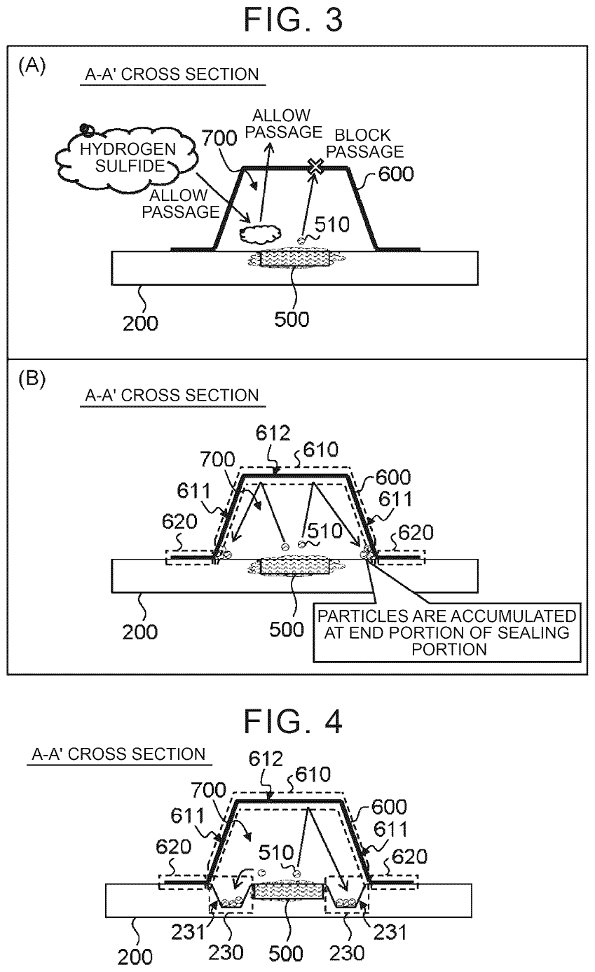

FIG. 3 is a schematic diagram for explaining the function of the filter 600 that covers the detection portion 500 of the substrate 200. As described above, the filter 600 is formed to allow passage of the hydrogen sulfide gas and to block passage of particles 510 generated from the corroded metal. Thus, as illustrated in the portion (A) in FIG. 3, the hydrogen sulfide gas generated from the battery cell passes through the filter 600 and flows into the space 700. The hydrogen sulfide that has flowed into the space 700 corrodes the metal of the detection portion 500. This allows the hydrogen sulfide detection device 10 to detect the generation of hydrogen sulfide. On the other hand, the filter 600 blocks passage of the particles 510 generated from the corroded metal. Thus, the particles 510 generated from the corroded metal remain within the space 700. In this manner, the filter 600 can suppress scattering of the particles 510 generated from the corroded metal within the battery pack.

Further, according to the first embodiment, the cover portion 610 includes the first surface 611 and the second surface 612. With the cover portion 610 including the first surface 611 and the second surface 612 in this manner, many of the particles 510 generated from the corroded metal can be accumulated at an end portion of the sealing portion 620, as illustrated in the portion (B) in FIG. 3. This makes it possible to suppress the particles 510 remaining within the space 700 obstructing the flow of the hydrogen sulfide gas. As a result, it is possible to suppress the detection accuracy of the hydrogen sulfide detection device 10 being reduced due to the particles 510 remaining within the space 700.

### 1.3 Effects

As described above, the hydrogen sulfide detection device 10 according to the first embodiment can detect the generation of hydrogen sulfide from the battery cell using the detection portion 500 of the substrate 200. In particular, according to the first embodiment, the detection portion 500 of the substrate 200 is covered by the filter 600 formed to allow passage of the hydrogen sulfide gas and to block passage of the particles 510 generated from the corroded metal. This makes it possible to suppress scattering of the particles 510 of the corroded metal while maintaining the detection function of the hydrogen sulfide detection device 10.

### 1.4 Modifications

The hydrogen sulfide detection device 10 according to the first embodiment can be modified in various ways. Modifications of the hydrogen sulfide detection device 10 according to the first embodiment will be described below.

### 1.4.1 First Modification

In a first modification, the substrate 200 is configured to have a recessed portion within the space 700 covered by the cover portion 610 of the filter 600. FIG. 4 is a schematic diagram illustrating an example of the first modification. In the example illustrated in FIG. 4, the substrate 200 has two recessed portions 230 within the space 700. The recessed portions 230 are each a groove formed in the surface of the substrate 200, for example.

According to the first modification, in which the substrate 200 has the recessed portions 230 within the space 700, the particles 510 of the corroded metal can be accumulated and retained in the recessed portions 230. This can further suppress the particles 510 obstructing the flow of the hydrogen sulfide gas. As a result, it is possible to further suppress the detection accuracy of the hydrogen sulfide detection device 10 being reduced by the particles 510.

Furthermore, in the example illustrated in FIG. 4, the recessed portions 230 have an inclined surface 231. This makes it easier for the particles 510 of the corroded metal to be accumulated in the recessed portions 230. Furthermore, the substrate 200 may be configured such that the entire portion of the substrate 200 within the space 700 other than the detection portion 500 is the recessed portion 230. Alternatively, the substrate 200 may be configured such that the recessed portion 230 is provided adjacent an end portion of the sealing portion 620 of the filter 600. Providing the recessed portion 230 in this manner also makes it easier for the particles 510 to be accumulated in the recessed portion 230. As a result, it is possible to further suppress the detection accuracy of the hydrogen sulfide detection device 10 being reduced by the particles 510.

### 1.4.2 Second Modification

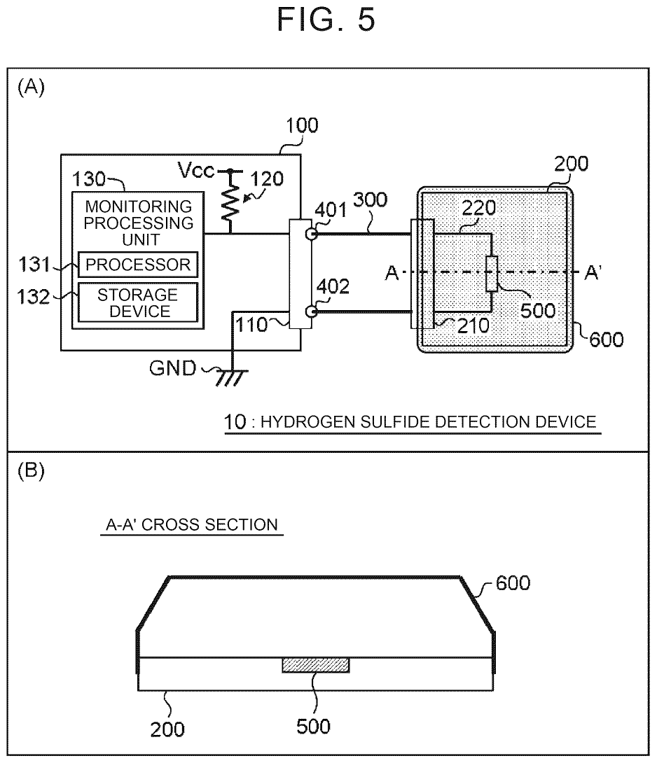

In a second modification, the filter 600 is configured to cover the entire substrate 200. FIG. 5 is a schematic diagram illustrating an example of the second modification. In FIG. 5, the portion (A) illustrates the overall configuration of the hydrogen sulfide detection device 10 according to the second modification, and the portion (B) illustrates a cross-sectional view taken along the cutting line A-A′ indicated in the portion (A). In the example illustrated in FIG. 5, the entire substrate 200 is covered by the filter 600.

In the second modification, the shape of the filter 600 is different from that of the first embodiment described above. However, also in the second modification, the detection portion 500 of the substrate 200 is covered by the filter 600. Thus, also in the second modification, it is possible to suppress scattering of the particles 510 of the corroded metal while maintaining the detection function of the hydrogen sulfide detection device 10. In this manner, the shape of the filter 600 is not particularly limited as long as the filter 600 covers the detection portion 500 of the substrate 200.

### 2. Second Embodiment

Next, a second embodiment will be described. The following description will focus on the differences from the first embodiment, and the description of contents that overlap with the first embodiment will be omitted as appropriate.

### 2.1 Configuration

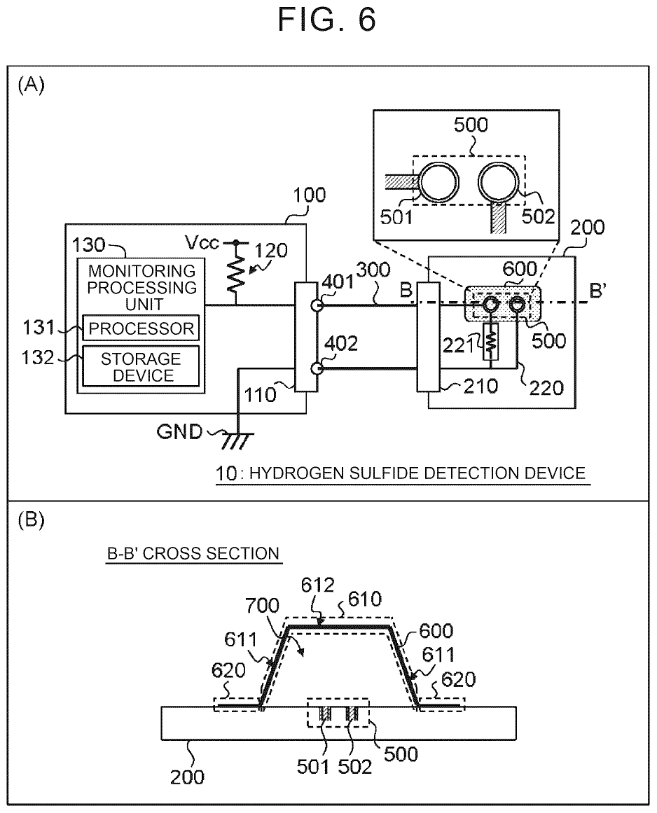

FIG. 6 is a schematic diagram illustrating the configuration of a hydrogen sulfide detection device 10 according to a second embodiment. The portion (A) in FIG. 6 illustrates the overall configuration of the hydrogen sulfide detection device 10 according to the second embodiment. The portion (B) in FIG. 6 illustrates a cross-sectional view taken along the cutting line B-B′ indicated in the portion (A).

The hydrogen sulfide detection device 10 according to the second embodiment includes a monitoring circuit 100 and a substrate 200, as in the first embodiment. The monitoring circuit 100 and the substrate 200 are connected by a cable 300. On the other hand, in the second embodiment, the configuration of a pattern 220 of the substrate 200 and a detection portion 500 is different from that in the first embodiment.

In the second embodiment, the detection portion 500 includes a first metal part 501 and a second metal part 502. The first metal part 501 and the second metal part 502 are each formed by exposing metal on a surface of the substrate 200. In particular, the first metal part 501 and the second metal part 502 are formed by a via or a through hole. The inner wall surface of a circular hole of the via or the through hole is plated with the same metal as the pattern 220.

The first metal part 501 is connected to a first node 401, and the second metal part 502 is connected to a second node 402, by the cable 300 and a wire formed by the pattern 220. In addition, the first metal part 501 is connected to the second node 402 via a resistive element 221. The resistive element 221 is, for example, a chip component having a resistance value of about 10 kΩ. As illustrated in FIG. 6, the first metal part 501 and the second metal part 502 are disposed adjacent to each other with a gap between the first metal part 501 and the second metal part 502. In particular, the first metal part 501 and the second metal part 502 are electrically insulated from each other by surface protection or the like applied to the substrate 200. That is, there is no electrical continuity between the first metal part 501 and the second metal part 502. The hydrogen sulfide detection device 10 according to the second embodiment can detect the generation of hydrogen sulfide, using the detection portion 500 including the first metal part 501 and the second metal part 502 described above, as follows.

At normal times, that is, when hydrogen sulfide is not being generated from the battery cell, there is no electrical continuity between the first metal part 501 and the second metal part 502, as described above. Thus, the monitoring processing unit 130 acquires the power supply voltage Vcc as the detection value. At abnormal times, that is, when hydrogen sulfide is being generated from the battery cell, the metal of the first metal part 501 and the second metal part 502 reacts with the generated hydrogen sulfide to be corroded. Then, the corroded metal (sulfide) spreads radially, and therefore the first metal part 501 and the second metal part 502 are connected by the sulfide. Since the sulfide is electrically conductive, this results in electrical continuity between the first metal part 501 and the second metal part 502. At this time, the monitoring processing unit 130 acquires the divided voltage due to the resistance value between the first node 401 and the second node 402 as the detection value. Here, the first metal part 501 and the second metal part 502 are adjacent to each other, and the resistance value of the sulfide connecting the first metal part 501 and the second metal part 502 is minute compared to a resistor 120. Thus, when the first metal part 501 and the second metal part 502 become electrically continuous, the potential of a ground GND is input almost as it is to the monitoring processing unit 130. That is, the monitoring processing unit 130 acquires the reference potential as the detection value.

In this manner, also in the second embodiment, when hydrogen sulfide is generated from the battery cell, the detection state of the detection portion 500 appears as the voltage between the first node 401 and the second node 402. That is, when hydrogen sulfide is generated from the battery cell, the detection value of the monitoring processing unit 130 changes from Vcc to the reference potential. Thus, the monitoring processing unit 130 can determine whether hydrogen sulfide is being generated from the battery cell based on a change in the detection value (the voltage between the first node 401 and the second node 402). The process flow of a process executed by the monitoring circuit 100 (more specifically, the monitoring processing unit 130) may be the same as that of the first embodiment (see FIG. 2). As described above, the hydrogen sulfide detection device 10 according to the second embodiment can detect the generation of hydrogen sulfide by the corrosion of the metal of the detection portion 500.

Furthermore, also in the hydrogen sulfide detection device 10 according to the second embodiment, the detection portion 500 of the substrate 200 is covered by a filter 600. As in the first embodiment, the filter 600 is formed to allow passage of the hydrogen sulfide gas and to block passage of particles 510 generated from the corroded metal. The filter 600 includes a cover portion 610 and a sealing portion 620, and the cover portion 610 includes a first surface 611 and a second surface 612.

### 2.2 Effects

As described above, the hydrogen sulfide detection device 10 according to the second embodiment can detect the generation of hydrogen sulfide from the battery cell using the detection portion 500 of the substrate 200. Furthermore, according to the second embodiment, as in the first embodiment, the detection portion 500 of the substrate 200 is covered by the filter 600 formed to allow passage of the hydrogen sulfide gas and to block passage of the particles 510 generated from the corroded metal. This makes it possible to suppress scattering of the particles 510 of the corroded metal while maintaining the detection function of the hydrogen sulfide detection device 10. Furthermore, according to the second embodiment, as in the first embodiment, the cover portion 610 of the filter 600 includes the first surface 611 and the second surface 612. This allows many of the particles 510 generated from the corroded metal to be accumulated at an end portion of the sealing portion 620. As a result, it is possible to suppress the detection accuracy of the hydrogen sulfide detection device 10 being reduced due to the particles 510 remaining within the space 700.

### 2.3 Modifications

The modifications (first modification and second modification) described in the first embodiment can also be applied as appropriate to the hydrogen sulfide detection device 10 according to the second embodiment.

### 3. Others

The first and second embodiments described above are different in the configuration of the detection portion 500 that detects hydrogen sulfide. On the other hand, in either of the embodiments, the same effect is achieved when the detection portion 500 is covered by the filter 600 formed to allow passage of the hydrogen sulfide gas and to block passage of the particles 510 generated from the corroded metal. In this manner, the technical feature of the present embodiment can also be applied as appropriate to the hydrogen sulfide detection device 10 including the detection portion 500 with other configurations.

What is claimed is:

1. A hydrogen sulfide detection device that is applied to a battery pack that stores a battery cell containing a sulfide-based electrolyte, comprising a substrate including a pattern made of a metal that reacts with hydrogen sulfide to be corroded, wherein:
the pattern includes a detection portion that detects the hydrogen sulfide by corrosion of the metal exposed on a surface of the substrate; and
the detection portion is covered by a filter that allows passage of a hydrogen sulfide gas and that blocks passage of particles generated from the corroded metal.

2. The hydrogen sulfide detection device according to claim 1, wherein:
the filter includes a cover portion that covers the detection portion and a sealing portion that adheres to the surface of the substrate and seals a space covered by the cover portion; and
the cover portion includes a surface that extends in an inclined manner from an end portion of the sealing portion toward an inside of the space, and a surface that faces the detection portion and is parallel to the surface of the substrate.

3. The hydrogen sulfide detection device according to claim 1, wherein the substrate has a recessed portion within a space covered by the filter.

4. The hydrogen sulfide detection device according to claim 3, wherein the recessed portion has an inclined surface.

5. The hydrogen sulfide detection device according to claim 1, further comprising a monitoring circuit, wherein:
the pattern is electrically connected between a first node and a second node; and
the monitoring circuit determines whether the hydrogen sulfide is generated from the battery cell based on a change in a voltage between the first node and the second node.
